(19) United States
(12) Patent Application Publication
(10) Pub. No.: US 2011/0185556 A1
(43) Pub. Date: Aug. 4, 2011

(54) ROBOT SYSTEM, ROBOT, AND METHOD OF MANUFACTURING PRODUCT

(75) Inventors: Yusuke HIRANO, Fukuoka (JP); Tomoki Kawano, Fukuoka (JP)

(73) Assignee: KABUSHIKI KAISHA YASKAWA DENKI, Kitakyushu-shi (JP)

(21) Appl. No.: 13/013,814

(22) Filed: Jan. 26, 2011

(30) Foreign Application Priority Data
Feb. 3, 2010 (JP) 2010-022592

(51) Int. Cl. B23P 11/00; B25J 9/00; B25J 15/00; B25J 18/00; B23P 19/00

(52) U.S. Cl. 29/428; 414/735; 29/700; 901/2; 901/27; 901/30

(57) ABSTRACT

A robot system includes a robot, a controller, a workbench, and a workpiece component supplier. The robot includes a body, a first arm, a second arm, a first hand, and a second hand. The robot is configured to transfer at least one of a plurality of types of workpiece components from the workpiece component supplier to the workbench by simultaneously holding each of the plurality of types of workpiece components with the first hand of the first arm and the second hand of the second arm. The robot is configured to transfer remaining types of workpiece components among the plurality of types of workpiece components from the workpiece component supplier to the workbench by holding each of the remaining types of workpiece components with only one of the first hand of the first arm and the second hand of the second arm.

### CROSS-REFERENCE TO RELATED APPLICATION

The present application claims priority under 35 U.S.C. §119 to Japanese Patent Application No. 2010-022592, filed Feb. 3, 2010. The contents of this application are incorporated herein by reference in their entirety.

### BACKGROUND OF THE INVENTION

1. Field of the Invention

The present invention relates to a robot system, a robot, and a method of manufacturing a product.

2. Description of the Related Art

Technologies for automation of operations that have been performed by humans to date have been proposed. For example, it is desirable to automate, using robots, complex operations that have been performed by humans to date, such as assembly of a mechanical product. Japanese Patent Laid-Open Publication No. 2009-000799 discloses a technology for automation of such a human operation.

### SUMMARY OF THE INVENTION

According to one aspect of the present invention, a robot system includes a robot, a controller, a workbench, and a workpiece component supplier. The robot includes a body, a first arm, a second arm, a first hand, and a second hand. The first arm is attached to the body and includes a plurality of joints. The second arm is attached to the body and includes a plurality of joints. The first hand is attached to the first arm. The second hand is attached to the second arm. The controller is configured to control motion of the robot. The robot performs an operation on a workpiece on the workbench. The workpiece component supplier is disposed around the robot to supply a plurality of types of workpiece components each of which is a component of the workpiece. The robot is configured to transfer at least one of the plurality of types of workpiece components from the workpiece component supplier to the workbench by simultaneously holding each of the plurality of types of workpiece components with the first hand of the first arm and the second hand of the second arm. The robot is configured to transfer remaining types of workpiece components among the plurality of types of workpiece components from the workpiece component supplier to the workbench by holding each of the remaining types of workpiece components with only one of the first hand of the first arm and the second hand of the second arm.

According to another aspect of the present invention, a robot includes a body, a first arm, a second arm, a first hand, a second hand, and a controller. The first arm is provided to the body and includes a plurality of joints. The second arm is provided to the body and includes a plurality of joints. The first hand is provided to the first arm. The second hand is provided to the second arm. The controller is configured to control each of the first arm and the second arm. The robot is configured to transfer at least one of a plurality of types of workpiece components from a workpiece component supplier to a workbench by simultaneously holding each of the plurality of types of workpiece components with the first hand of the first arm and the second hand of the second arm. The robot is configured to transfer remaining types of workpiece components among the plurality of types of workpiece components from the workpiece component supplier to the workbench by holding each of the remaining types of workpiece components with one of the first hand of the first arm and the second hand of the second arm.

According to further aspect of the present invention, a method of manufacturing a product includes preparing a plurality of types of workpiece components in a workpiece component supplier disposed around a robot. The robot includes a body, a first arm, a second arm, a first hand, and a second hand. The first arm is attached to the body and includes a plurality of joints. The second arm is attached to the body and includes a plurality of joints. The first hand is attached to the first arm. The second hand is attached to the second arm. At least one of the plurality of types of workpiece components is transferred from the workpiece component supplier to the workbench by simultaneously holding each of the plurality of types of workpiece components with the first hand of the first arm and the second hand of the second arm, the workbench being disposed in front of the robot. Remaining types of workpiece components among the plurality of types of workpiece components are transferred from the workpiece component supplier to the workbench by holding each of the remaining types of workpiece components with only one of the first hand of the first arm and the second hand of the second arm. The plurality of types of workpiece components are assembled on the workbench by using the first arm and the second arm.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic layout view illustrating the overall structure of a robot system according to an embodiment of the present invention;

FIG. 2 is a schematic perspective view illustrating the overall structure of the robot system according to the embodiment of the present invention;

FIG. 3 is a schematic perspective view illustrating the overall structure of the robot system according to the embodiment of the present invention; and

FIG. 4 is a flowchart illustrating the operation of the robot system according to the embodiment of the present invention.

### DESCRIPTION OF THE EMBODIMENTS

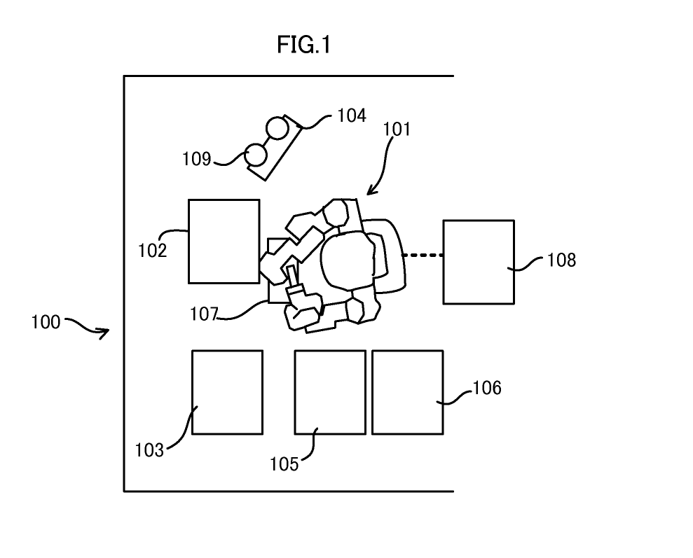

Hereinafter, an embodiment of the present invention will be described with reference to the drawings, wherein like reference numerals designate corresponding or identical elements throughout the various drawings. In the present embodiment, a cellular manufacturing system 100 is used as an example of an operation system. The cellular manufacturing system 100 makes a predetermined workpiece by machining and assembling four types of workpiece components W1 to W4. As illustrated in FIG. 1, the manufacturing system 100 according to the present embodiment includes a robot 101 (robot device), a stage 102 (workbench), component storage units 103 to 106 (workpiece component supplier), a tool storage unit 109, a bolt feeder 107, and a controller 108.

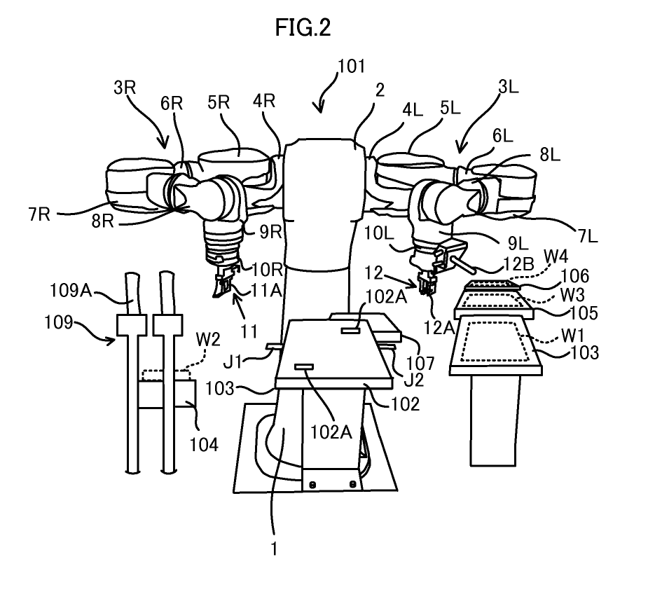

As illustrated in FIG. 2, the stage 102 is a flat table that is disposed in front of the robot 101 (at a position among the first arm, second arm, and a body, which will be described below). A plurality of stoppers, which define the position at which the workpiece component W1 is to be placed, are disposed on the stage 102. The component storage units 103 to 106 respectively store different types of workpiece components W1 to W4, each in multiple quantities. The component storage units 103 to 106 each may be a fixed shelf or may be a vehicle or a conveyer that transfers workpiece components to the manufacturing system 100. The robot 101 assembles the workpiece components W1 to W4 to make a workpiece W, which is a mechanical product. For simplicity, an example using four types of workpiece components is described here. However, the number of types of workpiece component may be appropriately changed in accordance with the assembly operation of the workpiece W.

The tool storage unit 109 stores power tools 109A of various types (such as a screw driver and a drill) and the like. General-purpose power tools that are used by a human can be used. The bolt feeder 107 stores bolts and the like that are used for assembling the workpiece W. In accordance with taught data, the bolt feeder 107 supplies various types of bolts that are required in a corresponding operation step.

The controller 108 is a computer including a memory (not shown), a processor (not shown), and an input device (not shown). The controller is communicatively connected to the robot 101.

Moving parts (turning parts, swinging parts, and hand units) of the robot 101, which will be described below, each include an actuator (not shown) including a servo motor and an encoder, and the encoder sends a signal representing the rotation position of the moving part to the controller 108. Taught data, such as data on operation steps for assembling the workpiece W (to be specific, data on the positions to which the moving parts of the robot 101 are to be moved, and the like) has been input to the controller 108 beforehand through an input device (such as a programming pendant). When the robot 101 performs an operation, an operation commander of the controller 108 sends motion signals to the moving parts of the robot 101 in accordance with the taught data stored in the memory.

Next, the structure of the robot 101 will be described. As illustrated in FIG. 2, the robot 101 has a base 1 that is fixed to the floor with anchor bolts (not shown). A body 2 is turnably mounted on the base 1 with an actuator therebetween. A right arm 3R (first arm) and a left arm 3L (second arm) are respectively disposed on the right side and on the left side of the body 2. The right arm 3R includes a right shoulder 4R (first structural member) that is attached to the body 2 with an actuator, which rotates around a first rotation axis that is horizontal (parallel to the floor), therebetween. A right upper arm A-portion 5R (second structural member) is attached to the right shoulder 4R with an actuator, which rotates around a second rotation axis that is perpendicular to the first rotation axis, therebetween. A right upper arm B-portion 6R (third structural member) is attached to an end of the right upper arm A-portion 5R with an actuator, which rotates around a third rotation axis that is perpendicular to the second rotation axis, therebetween.

A right lower arm 7R (fourth structural member) is attached to an end of the right upper arm B-portion 6R with an actuator, which rotates around a fourth rotation axis that is perpendicular to the third rotation axis, therebetween. A right wrist A-portion 8R (fifth structural member) is attached to an end of the right lower arm 7R with an actuator, which rotates around a fifth rotation axis that is perpendicular to the fourth rotation axis, therebetween. A right wrist B-portion 9R is attached to an end of the right wrist A-portion 8R with an actuator, which rotates around a sixth rotation axis that is perpendicular to the fifth rotation axis, therebetween. The right wrist A-portion 8R turns to perform a twisting operation, and the right wrist B-portion 9R turns to perform a bending operation. A right flange 10R is attached to an end of the right wrist B-portion 9R. The right flange 10R is rotatable by an actuator around a seventh rotation axis that is perpendicular to the sixth rotation axis. A right hand unit 11 (first hand) is attached to the right flange 10R. The right flange 10R is rotated by a servo motor, and thereby the right hand unit 11 (hand) can be turned and stopped (positioned) at a position that is commanded by the controller 108.

The right hand unit 11 includes an actuator (not shown) that changes the distance between two finger members 11A, so that the right hand unit 11 can grasp an object between the finger members 11A. The right hand unit 11 can also hold an object by inserting the finger members 11A in a hole (or the like) formed in the object, increasing the distance between the finger members 11A, and making the finger members 11A contact the inner surface of the hole.

The left arm 3L and the right arm 3R are horizontally symmetric. The left arm 3L includes a left shoulder 4L, a left upper arm A-portion 5L, a left upper arm B-portion 6L, a left lower arm 7L, a left wrist A-portion 8L, a left wrist B-portion 9L, and a left flange 10L. A left hand unit 12 (hand) is attached to the left flange 10L. As with the right hand unit 11, the left hand unit 12 includes an actuator (not shown) that changes the distance between two finger members 12A, so that the right hand unit 11 can grasp an object between the finger members 12A.

A bolt tool 12B is attached to the left hand unit 12, and extends in a direction substantially perpendicular to the finger members 12A. The bolt tool can take out a bolt from the bolt feeder 107, and screw the bolt into a taught position.

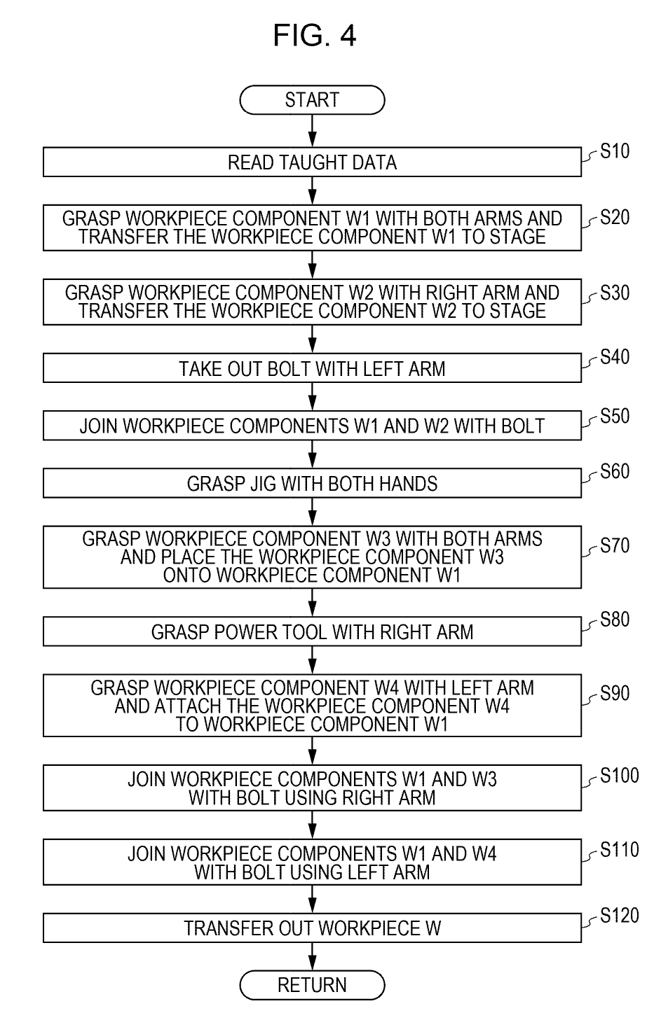

The manufacturing system according to an embodiment of the present invention has the structure described above. Hereinafter, the operation of the robot 101 that is taught by the controller 108, that is, the operation of making the workpiece W, will be described. As illustrated in FIG. 4, in step S10, when the operation starts, the controller 108 reads taught data that is stored in the memory. In step S20, the body 2 is turned relative to the base 1 so that the storage unit 103 is positioned approximately at the center of the left arm 3L and the right arm 3R. The finger members 11A of the right hand unit 11 grasp a predetermined taught position of the workpiece component W1. The finger members 12A of the left hand unit 12 grasp a different position of the workpiece component W1. While the right hand unit 11 and the left hand unit 12 grasp the workpiece component W1, the left arm 3L and the right arm 3R lift the workpiece component W1. The body 2 is turned toward the stage 102, and the workpiece component W1 is placed on the stage 102. The workpiece component W1 is placed at a taught position, and protrusions 102A, which are disposed on the stage 102, prevent the workpiece component W1 from slipping off the stage 102.

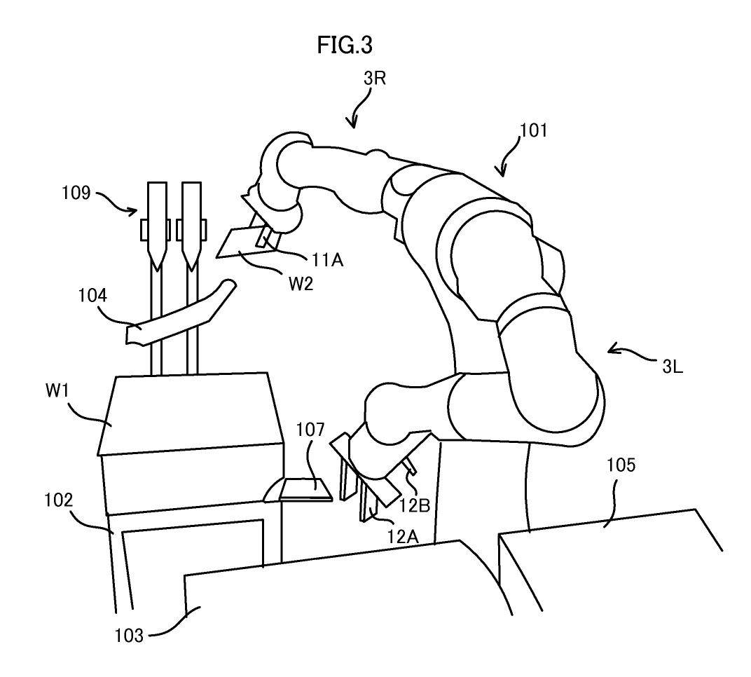

In step S30, the right arm 3R is moved. The right arm 3R grasps the workpiece component W2, which is disposed on the storage unit 104, with the right hand unit 11, and makes the workpiece component W2 be positioned next to a side surface of the workpiece component W1 on the stage 102 so as to contact the side surface. In step S40, which is performed simultaneously with step S30, the left arm 3L is moved toward the bolt feeder 107, and the left hand unit 12 takes out a bolt from the bolt feeder 107 by using the bolt tool 12B. In step S50, the left arm 3L is moved toward the workpiece component W2, which has been positioned by the right hand unit 11. The bolt tool 12B screws the bolt into the workpiece component W2 so that the workpiece component W2 is joined to the workpiece component W1 (see FIG. 3).

In step S60, the right hand unit 11 and the left hand unit 12 respectively grasp hook components J1 and J2 that are disposed on both sides of the stage 102. In step S70, the body 2 is turned toward the storage unit 105. The right hand unit 11 and the left hand unit 12 insert the hook portions of the hook components J1 and J2 into a lower part of the workpiece W3, and support the workpiece W3 with the hook portions. The left arm 3L and the right arm 3R lift the workpiece component W3, the body 2 is turned toward the stage 102, and the workpiece component W3 is positioned and placed on top of the workpiece component W1 on the stage 102.

In step S80, the right arm 3R is moved, and the right arm 3R grasps one of the power tools 109A, which is stored in the tool storage unit 109 and is taught by the controller. In step S90, which is performed simultaneously with step S80, the left arm 3L is moved. The left arm 31 grasps a taught position of the workpiece component W4 on the storage unit 106, and fits the workpiece component W4 into a fitting portion of the workpiece component W1 on the stage 102 (so as to be temporarily joined). When step S80 is finished, the right arm 3R takes out a bolt from the bolt feeder 107 by using an end of the power tool 109A, and joins the workpiece component W3 placed on the workpiece component W1 to the workpiece W1 with the bolt (step S100).

When step S90 is finished, the left arm 3L is moved toward the bolt feeder 107, and the left arm 3L takes out a bolt from the bolt feeder 107 by using the bolt tool 12B of the left hand unit 12, and joins the workpiece component W4 to the workpiece component W1 with the bolt (step S110). Thereafter, the workpiece W, which has been made by assembling the workpiece components W1 to W4, is transferred from the stage 102 to a transfer path (not shown), and the operations are repeated from step S10.

As described above, the manufacturing system according to the present embodiment has a structure that is similar to the upper body of a human in that the robot 101 has a body (the base 1 and the body 2) and arms disposed on both sides of the body. Therefore, the robot 101 can be used in an existing workspace that is designed for human operation without changing existing facilities such as the component storage units 103 to 106, the tool storage unit 109, and the bolt feeder 107. Accordingly, the cost for automating the operation can be reduced.

The workpiece components that are light or small (W2 and W4) are transferred only with one of the right arm 3R or the left arm 3L while the other arm performs another operation. The workpiece component that is heavy and large (W1) is transferred by the right arm 3R and the left arm 3L in cooperation, so that, even if each of the right arm 3R and the left arm 3L has a small maximum payload (i.e., a small size), the heavy workpiece component can be transferred with high precision. The workpiece that cannot be grasped with the finger members (W3) is supported by grasping the hook components J1 and J2 with the finger members and by operating the right arm 3R and the left arm 3L in cooperation by using a jig. Thus, workpiece components having various shapes can be transferred by providing the manufacturing system 100 with a simple jig, instead of making the structure complex by providing the hand units 11 and 12 with a special jig or a chuck mechanism.

A manufacturing system, a robot device, and a method of manufacturing a mechanical product according to the present invention are not limited to those of the embodiments described above.

Obviously, numerous modifications and variations of the present invention are possible in light of the above teachings. It is therefore to be understood that within the scope of the appended claims, the invention may be practiced otherwise than as specifically described herein.

What is claimed is:

1. A robot system comprising:
a robot comprising:
a body;
a first arm attached to the body and including a plurality of joints;
a second arm attached to the body and including a plurality of joints;
a first hand attached to the first arm; and
a second hand attached to the second arm;
a controller configured to control motion of the robot;
a workbench on which the robot performs an operation on a workpiece;
a workpiece component supplier disposed around the robot to supply a plurality of types of workpiece components each of which is a component of the workpiece;
the robot being configured to transfer at least one of the plurality of types of workpiece components from the workpiece component supplier to the workbench by simultaneously holding each of the plurality of types of workpiece components with the first hand of the first arm and the second hand of the second arm; and
the robot being configured to transfer remaining types of workpiece components among the plurality of types of workpiece components from the workpiece component supplier to the workbench by holding each of the remaining types of workpiece components with only one of the first hand of the first arm and the second hand of the second arm.

2. The robot system according to claim 1,
wherein the robot includes a base to turnably support the body.

3. The robot system according to claim 2,
wherein the robot includes an actuator to turn the base and the body.

4. The robot system according to claim 1,
wherein each of the first arm and the second arm includes
a first actuator configured to rotate a first structural member relative to the body,
a second actuator configured to rotate a second structural member relative to the first structural member around a second rotation axis perpendicular to
a first rotation axis of the first actuator,
a third actuator configured to rotate a third structural member relative to the second structural member around a third rotation axis perpendicular to the second rotation axis of the second actuator,
a fourth actuator configured to rotate a fourth structural member relative to the third structural member around a fourth rotation axis perpendicular to the third rotation axis of the third actuator,
a fifth actuator configured to rotate a fifth structural member relative to the fourth structural member around a fifth rotation axis is perpendicular to the fourth rotation axis of the fourth actuator, a sixth actuator configured to rotate a sixth structural member relative to the fifth structural member around a sixth rotation axis perpendicular to the fifth rotation axis of the fifth actuator, and a seventh actuator configured to rotate a first flange or a second flange relative to the sixth structural member around a seventh rotation axis perpendicular to the sixth rotation axis of the sixth actuator, and
wherein the first hand is attached to the first flange, and the second hand is attached to the second flange.

5. The robot system according to claim 1,
wherein the robot includes a memory to store motion data for a assembling a product, the motion data being input beforehand, and
wherein the controller is configured to control the motion of the robot in accordance with the motion data stored in the memory.

6. The robot system according to claim 1,
wherein a tool storage to store at least one type of tool is disposed in a vicinity of the robot, and
wherein the controller is configured to perform control so that the robot holds a tool of the at least one type of tool with the first hand of the first arm or the second hand of the second arm and performs an assembly operation on the plurality of types of workpiece components by using the tool.

7. The robot system according to claim 6,
wherein the controller is configured to perform control so that the robot simultaneously performs the assembly operation to transfer the remaining types of workpiece components with only one of the first hand of the first arm and the second hand of the second arm and the assembly operation to grasp the tool with another of the first hand of the first arm and the second hand of the second arm.

8. A robot comprising:
a body;
a first arm provided to the body and including a plurality of joints;
a second arm provided to the body and including a plurality of joints;
a first hand provided to the first arm;
a second hand provided to the second arm; and
a controller configured to control each of the first arm and the second arm;
the robot being configured to transfer at least one of a plurality of types of workpiece components from a workpiece component supplier to a workbench by simultaneously holding each of the plurality of types of workpiece components with the first hand of the first arm and the second hand of the second arm; and
the robot being configured to transfer remaining types of workpiece components among the plurality of types of workpiece components from the workpiece component supplier to the workbench by holding each of the remaining types of workpiece components with one of the first hand of the first arm and the second hand of the second arm.

9. A method of manufacturing a product comprising:
preparing a plurality of types of workpiece components in a workpiece component supplier that is disposed around a robot, the robot including a body, a first arm attached to the body and including a plurality of joints, a second arm attached to the body and including a plurality of joints, a first hand attached to the first arm, and a second hand attached to the second arm;
transferring at least one of the plurality of types of workpiece components from the workpiece component supplier to a workbench by simultaneously holding each of the plurality of types of workpiece components with the first hand of the first arm and the second hand of the second arm, the workbench being disposed in front of the robot; and
transferring remaining types of workpiece components among the plurality of types of workpiece components from the workpiece component supplier to the workbench by holding each of the remaining types of workpiece components with only one of the first hand of the first arm and the second hand of the second arm; and
assembling the plurality of types of workpiece components on the workbench by using the first arm and the second arm.

10. A method of manufacturing a product according to claim 9, further comprising:
grasping, which is performed simultaneously with the transferring of the remaining types of workpiece components by holding each of the remaining types of workpiece components with only one of the first hand of the first arm and the second hand of the second arm, a tool with another of the first hand of the first arm and the second hand of the second arm.
